(19) United States
(12) Patent Application Publication
(10) Pub. No.: US 2019/0009347 A1
(43) Pub. Date: Jan. 10, 2019

(54) CONDUIT HEATER REPLACEMENT TOOL

(71) Applicant: Consolidated Edison Company of New York, Inc., New York, NY (US)

(72) Inventor: Richard J. Trieste, JR., Staten Island, NY (US)

(21) Appl. No.: 15/641,633

(22) Filed: Jul. 5, 2017

(51) Int. Cl. B23B 51/04

(52) U.S. Cl. CPC B23B 51/0413; B23B 2251/02

(57) ABSTRACT

A tool and a method of replacing a heater element in a an LNG storage tank is provided. The tool includes a first cutting member having a plurality of teeth disposed about a circumference of an end, the first cutting member having a first hollow interior portion. A body having an end is coupled to the first cutting member opposite the plurality of teeth, the body having a second hollow interior portion, the second hollow interior portion being contiguous with the first hollow interior portion, the body having an enclosed second end opposite the first cutting member. A grinder/cutter member is operably coupled to the second end within the second hollow interior portion. A solid coupler is attached to the body and the grinder member, the coupler being configured to attach to a rotary tool.

### BACKGROUND

The subject matter disclosed herein relates to liquid natural gas (LNG) storage tanks, and in particular to a tool and method of replacing heater elements under the LNG storage tank.

LNG is natural gas that has been converted to a liquid to facilitate transport and storage. Natural gas transfers from vapor form to liquid form at about −260 degrees F. The natural gas is typically stored in a liquid form until it is needed to serve as a source of natural gas in an end use application, such as by transferring via a pipeline to end users. LNG storage tanks may be configured in one of multiple designs, with some built on a concrete slab. This slab is typically heated to prevent or reduce the risk of frost heave, or buckling due to ice lens formation. In some applications, conduits or tubes are arranged within the slab. Within the conduits, electrical heater elements, sometimes referred to as heat tracing, are positioned to generate the desired thermal energy. Heater elements fail for a variety of reasons, and when such an event occurs, the heater element is removed from the conduit and replaced.

In some instances, the replacement of the heater element may be hindered. For example, the heater element, or a portion of the heater element, may become stuck within the conduit due to debris, metal fusing from electrical shorts or ice. Since the conduits may only be accessed from the ends, replacement of the heater element could be a time consuming process. In the past, to clear the conduit a warm liquid, such as ethylene glycol, was circulated within conduit to unfreeze the heater elements. However, due to environmental concerns and a low success rate, this technique is not desirable in all circumstances.

Accordingly, while existing methods of replacing heater element are suitable for their intended purposes the need for improvement remains, particularly in providing a tool for removing stuck heater elements from an LNG storage tank conduit.

### BRIEF DESCRIPTION

According to one aspect of the disclosure, a tool used in the replacement of a heater element in an LNG storage tank is provided. The tool includes a first cutting member having a plurality of teeth disposed about a circumference of an end, the first cutting member having a first hollow interior portion. A body having an end is coupled to the first cutting member opposite the plurality of teeth, the body having a second hollow interior portion, the second hollow interior portion being contiguous with the first hollow interior portion, the body having an enclosed second end opposite the first cutting member. A grinder/cutter member is operably coupled to the second end within the second hollow interior portion. A solid coupler is attached to the body and the grinder member, the coupler being configured to attach to a rotary tool.

According to another aspect of the disclosure a method of replacing a heater element in a LNG tank is provided. The method includes removing a portion of a heater element from an end of a conduit in a LNG tank facility. A tool head is coupled to a rotary tool, the tool head having a diameter to fit within the conduit, the tool head having a first cutting member, a body and a grinding/cutting member, the first cutting member having a plurality of teeth disposed about a circumference of an end, the first cutting member having a first hollow interior portion, the body having an end coupled to the first cutting member opposite the plurality of teeth, the body having a second hollow interior portion, the second hollow interior portion being contiguous with the first hollow interior portion, the body having an enclosed second end opposite the first cutting member, and the grinder/cutter member operably coupled to the second end within the second hollow interior portion. The tool head is inserted into the conduit. The tool head is rotated with the rotary tool and moving the tool head along the length of the conduit. The first cutting member is used to cut a first portion of the heater element within the conduit. The first portion is cut into smaller portions with the grinder member after the first portion is cut within the conduit.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view, partially in section, of an LNG storage tank;

FIG. 2 is a perspective view, partially in section, of an enlarged portion of the LNG storage tank of FIG. 1 in accordance with an embodiment;

FIG. 3 is a side sectional view of a tool for removing heater elements in accordance with an embodiment; and

FIG. 4 is a side sectional view of a heater conduit with the tool of FIG. 3 inserted for removing stuck elements.

The detailed description explains embodiments of the disclosure, together with advantages and features, by way of example with reference to the drawings.

### DETAILED DESCRIPTION

Embodiments of the present invention provide for a tool that allows for removal of heater elements that are stuck within a heater conduit due to debris, icing or electrical shorts. Embodiments further provide for a tool that removes heater elements with a reduced risk of the tool being stuck or jammed within the heater conduit.

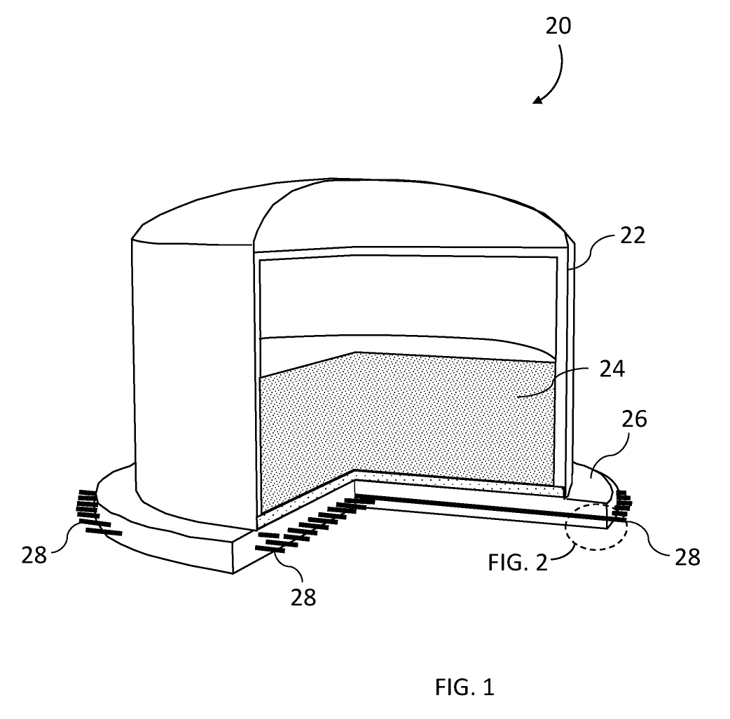

Liquefied natural gas (LNG) is typically stored within a facility 20 having an insulated tank 22 as is shown in FIG. 1. The insulated tank 22 contains LNG 24 and will also have systems for removal of the LNG and boiled-off natural gas as is known in the art. The insulated tank 22 is positioned on top of a concrete slab 26. Within the slab 26 a plurality of heater conduits 28 are arranged. Typically, the heater conduits 28 are arranged in a manner to reduce the risk of frost heave or buckling of the slab 26 due to the cold temperatures used to maintain the natural gas within a liquid state. It should be appreciated that reducing the risk of frost heaves or buckling is required to maintain the structural integrity of the insulated tank 22 and maintaining the operational status of the facility 20. It should be further appreciated that many of the LNG tanks in the United States are in service in cities being operated by local gas distribution company's (LDCs) under “grandfather” provisions and as such a structural problem from a frost heave of the tank will result in the tank being permanently removed from service resulting in an impact of the LDC to serve its customers.

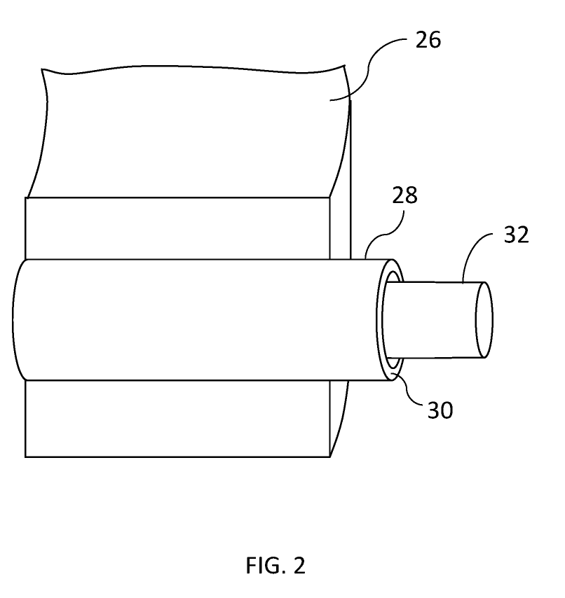

Referring now to FIG. 2, with continuing reference to FIG. 1, an enlarged portion of the slab 26 is shown adjacent an egress point 30 of a heater conduit 28. Disposed within the heater conduit 28 is a heater element assembly 32. Typically, in the assembly 32, may include components such as but not limited to copper bus wires, nichrome heater elements, one or more insulators, a copper/grounding braid and an over-jacket. It should be appreciated that one or more portions of the assembly 32 may become stuck within the heater conduit 28 making replacement of the assembly 32 not possible. Further, in order for the new heater element assembly to be installed, the conduit 28 should be free of the failed heating element and any debris.

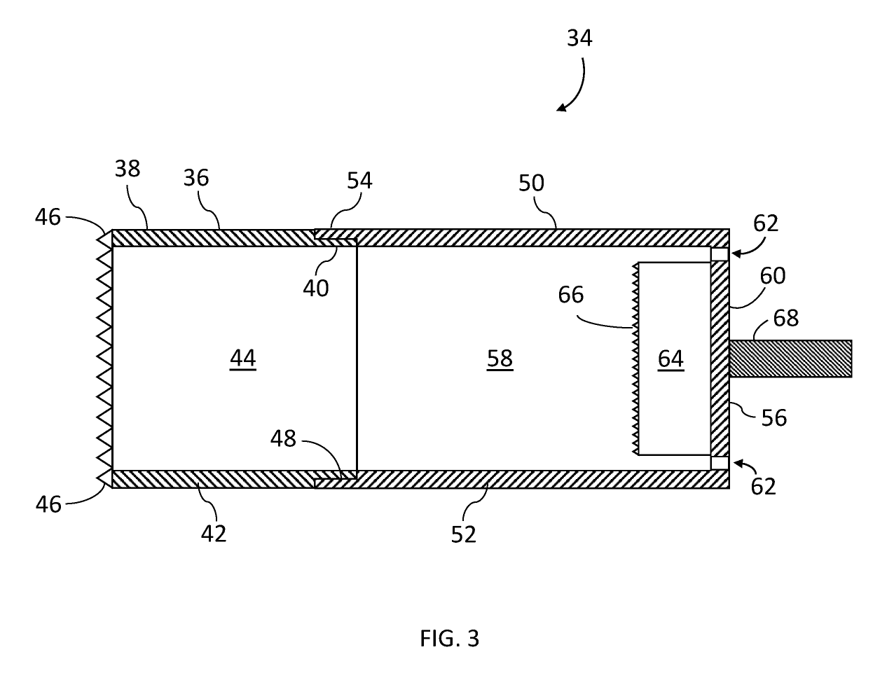

Referring now to FIG. 3, a tool 34 is shown that may be used to remove heater element assemblies 32 that have become stuck within the heater conduit 28. The tool 34 includes a cutting member 36 having a body 42 with a first end 38 and a second end 40. The body 42 defines a hollow interior area 44 that extends from the first end 38 to the second end 40. The body 42 has a diameter sized to fit within the inner diameter of the heater conduit 28. The first end 38 includes a plurality of cutting elements 46 that are disposed about the periphery of the first end 38. In an embodiment, the cutting elements 46 are generally triangular in shape with a point extending away from the body 42. In other embodiments, the cutting elements may have a cutting edge extending along a side of the cutting element, with the cutting edge being generally parallel to the axis of the tool 34.

In an embodiment, the second end 40 includes a fastening element 48, such as threads for example that allow the cutting member 36 to be removably coupled to a tubular member 50. It should be appreciated that providing a replaceable cutting member 36 provides advantages in allowing the changing of the cutting member 36 when the cutting elements become worn or dull. The tubular member 50 includes a body 52 having a first end 54 and a second end 56. The body 52 defines a hollow interior area 58 that extends from the first end 54 to a wall 60 on the second end 56. The interior area 58 is contiguous with the interior area 44. In an embodiment, the wall 60 includes openings 62 that allow in operation for material within the interior area 58 to pass through into the conduit 28. In the exemplary embodiment, the body 52 has a diameter sized to fit within the internal diameter of conduit 28. In an embodiment, the body 52 has a diameter that is the same as the body 42.

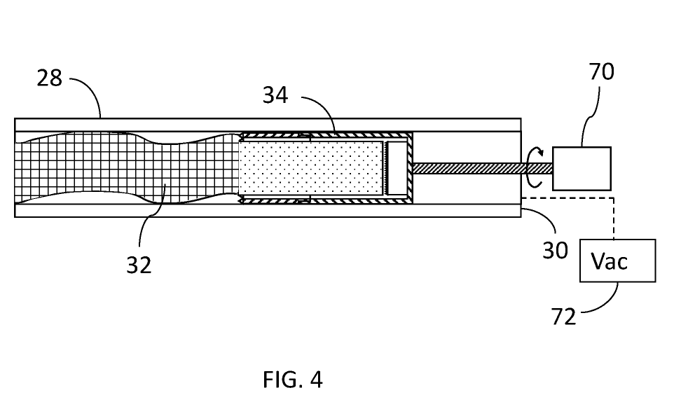

Coupled to the wall 60 within the interior area 58 is a grinder/cutter member 64. In an embodiment, the grinder/cutter member 64 includes a plurality of cutting elements 66 disposed on a planar face opposite the wall 60. In the exemplary embodiment, the grinder member 64 is removably coupled to the wall 60. In another embodiment, the grinder/cutter member 64 is removably coupled to a shaft 68 that extends from the second end 56. It should be appreciated that a replaceable grinder member 64 provides advantages in allowing the changing of the grinder element as the cutting elements 66 become worn or dull. In another embodiment, the grinder member 64 may be a spade type drill having an arcuate cutting surface. The shaft 68 is configured to couple with a rotary tool 70 (FIG. 4), such as a drilling device for example. In an embodiment, the shaft 68 may include features that allow extension shafts (not shown) to be added as the tool 34 is advanced into the conduit 28.

In the exemplary embodiment, the cutting member 36 and the tubular member 50 are made from a hardened steel. In an embodiment, the length of the tool 34 from the first end 38 to the second end 56 may be between 6 inches to 18 inches.

Referring now to FIG. 4, with continuing reference to FIG. 3, a method of operating the tool 34 to remove heater elements 32 from the heater conduit 28. The method of replacing the heater element assembly 32 begins with exposing the egress 30 and pulling the assembly 32 outward and away from the conduit 28. In some instances, one or more portions of the assembly 32 may become coupled to the inner diameter of the conduit 28. These portions may be coupled or stuck due to ice formation, debris within the conduit 28, or due to electrical arcing that fuses one the portions to the surface of the inner diameter of conduit 28. It should be appreciated that these reasons may typify common reasons for the heater element assembly 32 becoming stuck, but the claims should not be limited by any theory.

The tool 34 is coupled by the shaft 68 to a rotary device 70. It should be appreciated that rotational motion imparted by the rotary device 70 onto the shaft 68 will cause the cutting member 36, the tubular member 50 and the grinder member 64 to rotate as well. The tool 34 is placed within the conduit 28 and the rotary device engaged/activated. In the exemplary embodiment, the outer diameter of the tool 34 is closely matched to the inside diameter of the conduit 28. Therefore, as the tool 34 is advanced into and through the conduit 28, the cutting elements 46 will engage the portions of the heater element assembly 32 that remain within the conduit 28 and stuck to the surface of the inner diameter. The cutting elements 46 will cut through the softer (relative to the hardened steel tool 34) materials of the heater element assembly 32 that are stuck or fused to the conduit 28. It should be appreciated that this has the effect of clearing the inner diameter of the conduit 28.

The removed portions of heater element that are cut away from the inner diameter of the conduit 28 then pass through the interior area 44 and into the interior area 58 or are retained in the space left unoccupied in the conduit by element 32 and tool 34. Due to the pressure from incoming material and the movement/advancement of the tool 34, the material/portions within the interior area 58 will be forced against cutting elements 66, resulting the portions being broken into finer or smaller pieces. In an embodiment, the ground material passes through the openings 62 and into the area of the conduit 28 adjacent the shaft 68. In one embodiment, a vacuum device 72 applies a vacuum to the egress 30 to clear the cutaway portions of the heater element. In one or more embodiments, the tool 34 is periodically removed from the conduit 28 and cutaway portions removed by insertion of vacuum device 72. In one or more embodiments, the vacuum device 72 is coupled to the egress 30 after the tool 34 has been removed from the conduit 28. In one or more embodiments, the process of cutting the heater element portions, removing the tool 34 and the cutaway portions from the conduit and applying the vacuum to the egress 30 are performed repeatedly until the conduit 28 is cleared or substantially cleared of the portions of the heater element 32. Once the conduit 28 is cleared, a new heater element assembly 32 may be inserted via the egress 30 and pulled through to the opposing egress.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A tool comprising:
a first cutting member having a plurality of teeth disposed about a circumference of an end, the first cutting member having a first hollow interior portion;
a body having an end coupled to the first cutting member opposite the plurality of teeth, the body having a second hollow interior portion, the second hollow interior portion being contiguous with the first hollow interior portion, the body having an enclosed second end opposite the first cutting member;
a grinder/cutter member operably coupled to the second end within the second hollow interior portion; and
a solid coupler attached to the body and the grinder/cutter member, the solid coupler being configured to attach to a rotary tool.

2. The tool of claim 1, wherein the first cutting member is removably coupled to the body.

3. The tool of claim 2, wherein the grinder/cutter member is removably coupled to the body.

4. The tool of claim 1, wherein the grinder/cutter member is a planar grinder.

5. The tool of claim 1, wherein the grinder/cutter member is a spade drill.

6. A system for replacing a heater conduit of an LNG tank, the system comprising:
a rotary tool; and
a tool head coupled to the rotary tool, the tool head comprising:
a first cutting member having a plurality of teeth disposed about a circumference of an end, the first cutting member having a first hollow interior portion, wherein the first cutting member is sized to be received by the heater conduit;
a body having an end coupled to the first cutting member opposite the plurality of teeth, the body having a second hollow interior portion, the second hollow interior portion being contiguous with the first hollow interior portion, the body having an enclosed second end opposite the first cutting member, wherein the first cutting member is sized to be received by the heater conduit;
a grinder/cutter member operably coupled to the second end within the second hollow interior portion; and
a solid coupler attached between the body and the rotary tool.

7. The tool of claim 6, wherein the first cutting member is removably coupled to the body.

8. The tool of claim 7, wherein the grinder/cutter member is removably coupled to the body.

9. The tool of claim 6, wherein the grinder/cutter member is a planar grinder/cutter.

10. The tool of claim 6, wherein the grinder/cutter member is a spade drill.

11. A method of replacing a heater element in a LNG tank, the method comprising:
removing a portion of the heater element from an end of a conduit in a LNG tank facility;
coupling a tool head to a rotary tool, the tool head having a diameter to fit within the conduit, the tool head having a first cutting member, a body and a grinding/cutting member, the first cutting member having a plurality of teeth disposed about a circumference of an end, the first cutting member having a first hollow interior portion, the body having an end coupled to the first cutting member opposite the plurality of teeth, the body having a second hollow interior portion, the second hollow interior portion being contiguous with the first hollow interior portion, the body having an enclosed second end opposite the first cutting member, and a grinder/cutter member operably coupled to the second end within the second hollow interior portion;
inserting the tool head into the conduit;
rotating the tool head with the rotary tool and moving the tool head along a length of the conduit;
cutting, with the first cutting member, a first portion of the heater element within the conduit; and
cutting the first portion into smaller portions with the grinder/cutter member after the first portion is cut within the conduit.

12. The method of claim 11, removing the tool head from the conduit when the smaller portions fill the second hollow interior portion.

13. The method of claim 12, moving the tool head along the length of the conduit to remove any remaining portion of the heater element.

14. The method of claim 13, further comprising installing a second heater element into the conduit.

15. The tool of claim 11, wherein the first cutting member is removably coupled to the body.

16. The tool of claim 15, wherein the grinder/cutter member is removably coupled to the body.

17. The tool of claim 15, wherein the grinder/cutter member is a planar grinder.

18. The tool of claim 15, wherein the grinder/cutter member is a spade drill.
